(19) United States
(12) Patent Application Publication
(10) Pub. No.: US 2020/0200475 A1
(43) Pub. Date: Jun. 25, 2020

(54) DEHYDRATION BELOW THE TRIPLE POINT OF WATER

(71) Applicant: EnWave Corporation, Delta (CA)

(72) Inventors: Timothy D. DURANCE, VANCOUVER (CA); Reihaneh NOORBAKHSH, Vancouver (CA); JUN FU, PORT COQUITLAM (CA); Gary SANDBERG, Chilliwack (CA)

(21) Appl. No.: 16/613,331

(22) PCT Filed: May 16, 2017
(86) PCT No.: PCT/CA17/50594

§ 371 Date: Nov. 13, 2019

(51) Int. Cl. F26B 5/04; F26B 5/06; F26B 21/10; A23B 7/024; F26B 25/08

(52) U.S. Cl. CPC F26B 5/048; F26B 5/06; F26B 25/08; A23B 7/024; F26B 21/10

(57) ABSTRACT

A method of drying an organic material by microwave-vacuum drying below but close to the triple point of water has been determined to allow more conversion of microwaves to heat than would occur when microwave freeze-drying at lower pressures. The method comprises introducing the organic material into a microwave-vacuum dehydrator, exposing the organic material to microwave radiation in the dehydrator to dry the organic material by sublimation, and maintaining pressure in the dehydrator in the range of 0.5 Torr to 4.5 Torr. The method provides the benefits of reduced drying time, energy requirements and product temperatures, relative to dehydration done at lower vacuum pressures.

### FIELD OF THE INVENTION

The invention pertains to methods and apparatus for dehydration of organic materials using microwave-vacuum drying at pressures below the triple point of water.

### BACKGROUND OF THE INVENTION

It is known in the food processing art to make organic materials, such as dehydrated food products, by means of microwave-vacuum dehydration. Examples in the patent literature include WO 2014/085897 (Durance et al.), which discloses the production of dehydrated cheese pieces, and U.S. Pat. No. 6,313,745 (Durance et al.), which discloses the production of dehydrated berries.

It is known in the art to conduct the drying process at a wide range of vacuum pressures, including pressures both below and above the triple point of water, i.e. 4.58 Torr (611 Pa).

US 2016/0157501 (Monckeberg) discloses a method of using microwave energy to accelerate freeze-drying of produce, involving the steps of: freezing the produce; reducing the pressure of the frozen produce to a pressure that facilitates sublimation; applying a first microwave power to the produce; and applying a second microwave power to the produce when the produce temperature exceeds a threshold value. The pressure may be reduced to various pressures from 1 mbar (0.75 Torr) to 0.03 mbar (0.022 Torr).

U.S. Pat. No. 9,459,044 (Haddock et al.) discloses a pressure-activated heater cycling method, comprising the steps of: decreasing the pressure in a chamber to a first vacuum pressure; activating a heater in response to the decrease in pressure within the chamber thereby allowing solid water to sublimate; and deactivating the heater when the chamber reaches a pressure greater than a second vacuum pressure. The first vacuum pressure is about 0.05 to about 0.4 Torr, and the second vacuum pressure is about 0.055 to about 1 Torr.

U.S. Pat. No. 9,554,583 (Hollard) discloses a process for preparing a freeze dried microorganism composition. The method comprises the steps of subjecting a frozen composition comprising microorganisms to a drying pressure of from 133 Pa (1 Torr) to 338 Pa (2.54 Torr).

US 2008/0142166 (Carson et al.) discloses a method for use in spray freeze drying of a fluid substance. The frozen fluid substance is directed into a vacuum chamber for sublimation. The chamber may have a heating source. The drying chamber is maintained at an absolute pressure of 200-400 micrometers of Hg (0.2-0.4 Torr).

US 2007/0184173 (Adria) discloses a process of preparing a food product comprising a freezing step, a primary drying step and a secondary drying step. The primary drying step involves removing the frozen solvent (water) by sublimation by lowering the pressure in the system to lower than or close to the triple point of the frozen solvent. In an example, the food product is maintained within a chamber in which the absolute pressure is 100 micrometers of Hg (0.1 Torr) or less.

WO 2017/007309 (Calis) discloses a method for freeze-drying batches of solid frozen protein-rich food products. The vacuum in the vessel is reduced, thereby allowing frozen water to sublimate, and heat is supplied to the frozen products. The vacuum is less than 1000 Pa (7.5 Torr), or less than 20 Pa (0.15 Torr), or 10-50 Pa (0.075-0.375 Torr).

Continuing technical challenges in the field include high power usage, high operating costs, lengthy drying time, high product temperature, reactions causing discoloration of the product, and difficulty of maintaining the structure of the product. The present invention is directed to improvements in microwave-vacuum drying that reduce one or more of these problems.

### SUMMARY OF THE INVENTION

The invention provides a method of dehydrating organic materials in a microwave-vacuum dehydrator at pressures below but close to the triple point of water.

One aspect of the invention provides a method of drying an organic material comprising: (a) introducing the organic material into a microwave-vacuum dehydrator (b) exposing the organic material to microwave radiation in the dehydrator to dry the organic material by sublimation; (c) maintaining pressure in the dehydrator in the range of 0.5 Torr to 4.5 Torr during the dehydration; and (d) removing the dried organic material from the dehydrator.

Another aspect of the invention provides a method of drying an organic material comprising: (a) exposing the organic material to microwave radiation in a vacuum chamber; (b) maintaining conditions in the vacuum chamber below the triple point of water, with a pressure in the vacuum chamber in the range of 0.5 Torr to 4.5 Torr, during step (a); and (c) removing the dried organic material from the vacuum chamber.

Another aspect of the invention provides a method as above that further comprises the steps of compressing water vapour generated by the drying and thereby raising its temperature, and condensing the compressed water vapour.

Another aspect of the invention provides an apparatus for dehydrating organic matter, comprising: (a) a vacuum chamber; (b) a magnetron arranged to radiate microwaves into the vacuum chamber; (c) a vacuum source for reducing pressure inside the vacuum chamber; and (d) means for maintaining the pressure inside the vacuum chamber in the range of 0.5 Torr to 4.5 Torr. The apparatus may further comprise: (e) a vapour pressure booster pump arranged downstream of the vacuum chamber for compressing water vapour produced in the vacuum chamber; and (f) a condenser arranged downstream of the vapour pressure booster pump for condensing the compressed water vapour.

Another aspect of the invention provides an apparatus for dehydrating organic matter, comprising: (a) a vacuum chamber; (b) a magnetron for radiating microwaves into the vacuum chamber; (c) a vacuum source for reducing pressure inside the vacuum chamber; and (d) means for maintaining conditions in the vacuum chamber below the triple point of water, with the pressure inside the vacuum chamber in the range of 0.5 to 4.5 Torr. The apparatus may further comprise: (e) a vapour pressure booster pump arranged downstream of the vacuum chamber for compressing water vapour produced in the vacuum chamber; and (f) a condenser arranged downstream of the vapour pressure booster pump for condensing the compressed water vapour.

Further aspects of the invention and features of specific embodiments of the invention are described below.

### BRIEF DESCRIPTION OF THE DRAWINGS

FIG. 1 is a schematic longitudinal section view of a dehydration apparatus according to one embodiment of the invention.

### DETAILED DESCRIPTION

The invention provides a method of microwave-vacuum drying of organic materials at a pressure below but close to the triple point of the water in the material, e.g., at a pressure maintained in the range of about 0.5 to 4.5 Torr (67 Pa to 600 Pa) absolute pressure. For brevity of description, such drying is referred to herein as “triple point drying,” though it will be understood that the invention does not pertain to drying at the triple point itself, only below it.

In conventional low-pressure microwave-vacuum drying processes, a sample is frozen and subjected to microwave radiation in a very low pressure vacuum chamber, typically less than 200 mTorr (27 Pa), to remove water through sublimation. The microwaves provide the heat energy available to be absorbed by the product in drying and the pressure controls the sublimation temperature of the water and therefore the drying temperatures, as long as crystalized water (ice) is present in the product.

The present inventors have found that drying at temperatures and pressures higher than conventional low-pressure drying, below but close to the triple point of water, is advantageous because it allows more conversion of microwaves to heat than would occur when microwave freeze-drying at lower pressures. The conversion of microwaves to heat is strongly influenced by the dielectric loss factor of the material in which the microwaves are absorbed: the higher the loss factor, the more heat is generated from a given microwave field. Very low loss factor materials are sometimes referred to as “transparent” to microwaves because microwaves tend to pass through without being absorbed and therefore without creating heat. In addition, as a frozen organic material is heated from a low temperature until it approaches the freezing point/triple point, the loss factor increases progressively. Higher loss factor means faster energy transfer to the frozen material and therefore faster drying. This means that drying close to the triple point can be much faster than microwave-vacuum drying at pressures less than about 0.5 Torr (67 Pa), or less than 1 Torr (133 Pa).

In the triple point drying process, the pressure and power optimization are controlled to determine an optimum range of temperatures where the loss factor is such as to allow enough absorption of microwaves to give rapid drying while still enough ice structure is maintained in the sample to control or prevent fluid flow of the material and thus prevent or limit collapse, puffing and foam formation. Collapse occurs when the wet or partially dried material flows in upon itself and closes pores left by the loss of water and ice. Once a material collapses, the drying rate is dramatically reduced and the material may never reach very low moisture. Puffing occurs when expanding steam forms bubbles in material that has begun to flow. Foaming is an extreme form of puffing. A benefit of triple point drying over conventional microwave-vacuum drying that is carried out above the triple point of water is control or prevention of collapse, puffing and foam formation. In the process of the invention, the power is optimized to provide enough energy for maximum sublimation while maintaining temperature and pressure below the triple point. Microwave power is controlled by means of a programmable logic controller (PLC).

Products that have the potential to make foam during microwave-vacuum drying need to be kept frozen during the primary stage of drying to prevent foaming. Examples of such products are some pharmaceutical formulations, yogurt, fruit juices and fruit extracts. Using the process of the invention, the sponge-like structure of the product is formed and fixed by sublimation, then rapid drying and low final moistures can be achieved. The low moisture and water activity of such dried products help them to be more shelf-stable.

During the primary drying stage, sublimation occurs mainly as a result of the heat supplied by controlled microwave power to the sublimation interface through the dried and frozen layers. During the secondary drying stage, water that did not freeze is removed by desorption from the solute phase. The heat of desorption required by the bound water molecules during the secondary drying stage is supplied by the microwave power.

When an organic material freezes, not all of the water is in ice structures, i.e. frozen. Some water will be present in droplets of concentrated, unfrozen solutions. Some will be hydrogen-bonded to the polar surfaces of solid materials. Even in pure water, ice crystals are not entire stable, so some water molecules are continually associating with and dissociating from the ice crystals. The dissociated water is not frozen since it is not incorporated in an ice crystal. The lower the temperature is reduced below the freezing point, the larger the proportion of frozen water, but in theory some water will always remain unfrozen. This is illustrated by the following table, showing the percentage of frozen water ((g ice/g total initial water)×100) in various food materials, at selected temperatures.

| | Lean Meat¹ | Haddock² | Egg White³ | Various Fruits |
|---|---|---|---|---|
| Temperature | (72.5% | (83.6% | (86.5% | and Vegetables⁴ |
| (° C.) | water) | water) | water) | (80-92% water) |
| 0 | 0 | 0 | 0 | 0 |
| −10 | 83 | 86.7 | 92 | 77-86 |
| −20 | 88 | 90.6 | 93 | 85-91 |
| −30 | 89 | 92 | 94 | 91-94 |
| −40 | — | 92.2 | — | — |

¹L. Reidel, [symbol] 9, (1957): 38.
²L. Reidel, [symbol] 8, (1956): 374.
³L. Reidel, [symbol] 9, (1957): 342.
⁴Dickerson, R W J, “Enthalpy of frozen foods,” Handbook and Product Directory Fundamentals, (1981), American Society of Heating, Refrigeration and Air Conditioning. New York.

The interaction of organic materials with electromagnetic radiation, including microwaves, is governed by the dielectric properties of the material, specifically the relative dielectric constant e′ and the relative dielectric loss factor e″. Between them, the dielectric properties determine the proportion of incident microwaves that are reflected, or pass through, or are absorbed by the material and are converted to heat.

Ice has a much lower dielectric loss factor than unfrozen water; for example, at 2450 MHz microwave frequency, pure ice has a loss factor of 0.003 at 0° C. while liquid water at the same temperature has a loss factor of 21. Therefore, as more water becomes frozen, the dielectric loss factor decreases and the material becomes more transparent to microwaves, i.e. more microwaves pass through and less are converted to heat. Changes in the dielectric properties of the sample throughout the drying process alter the ability of microwaves to generate heat.

There is a well-established relationship between pressure and the sublimation temperature of water. For example, a pressure of 100 mTorr (13 Pa) corresponds to a sublimation temperature of −43° C., and a pressure of 750 mTorr (100 Pa) corresponds to a sublimation temperature of −21° C. The pressure in the vacuum chamber can therefore be varied to control the sublimation temperature. In the process of the invention, the temperature and pressure can be varied by adjusting microwave radiation to accelerate or decelerate the primary and secondary drying so as to promote rapid drying while avoiding structural collapse. A benefit of using triple point drying, as compared to lower pressure drying conditions, is better efficiency due to the increase of the dielectric loss factor at the higher pressures (while still remaining below the triple point pressure). For example, the loss factor at 100 mTorr is less than 0.45, while the loss factor at 750 mTorr is 1.03.

In some embodiments, the microwave power is adjusted during the drying process to allow the product to absorb the maximum amount of microwave radiation, needed to promote rapid dehydration, but consistent with keeping the physical conditions of the product below the triple point so as to maintain the crystalline structure of the material and avoid collapse of that structure.

According to one embodiment of the drying method, the organic material is subjected to drying by means of microwave radiation and reduced pressure in a microwave-vacuum dehydrator. It will be understood that “drying” means that the moisture level is reduced to a desired level, not necessarily or typically to zero.

Examples of organic materials that are suitable for dehydration by the method of the invention include: fruit, either whole, puree or pieces, either frozen or un-frozen, including banana, mango, papaya, pineapple, melon, apples, pears, cherries, berries, peaches, apricots, plums, grapes, oranges, lemons, grapefruit; vegetables, either fresh or frozen, whole, puree or pieces, including peas, beans, corn, carrots, tomatoes, peppers, herbs, potatoes, beets, turnips, squash, onions, garlic; fruit and vegetable juices; pre-cooked grains including rice, oats, wheat, barley, corn, flaxseed; hydrocolloid solutions or suspensions, vegetable gums; frozen liquid bacterial cultures, vaccines, enzymes, protein isolates; amino acids; injectable drugs, pharmaceutical drugs, natural medicinal compounds, antibiotics, antibodies; composite materials in which a hydrocolloid or gum surrounds and encapsulates a droplet or particle of a relatively less stable material as a means of protecting and stabilizing the less sensitive material; meats, fish and seafoods, either fresh or frozen, either whole, puree or pieces; dairy products such as milk, cheese, whey proteins isolates and yogurt; and moist extracts of fruits, vegetables and meats.

The dehydrator may be a continuous throughput- or batch-type machine. An example of a microwave-vacuum dehydrator suitable for carrying out the step of drying is a travelling wave-type apparatus, as shown in WO 2011/085467 (Durance et al.), commercially available from EnWave Corporation of Vancouver, BC, Canada, under the trademark quantaREV. The organic material is fed into the vacuum chamber and conveyed across a microwave-transparent window on a conveyor belt while being subjected to drying by means of reduced pressure and microwave radiation. The pressure in the vacuum chamber is maintained in the range of 0.5 to 4.5 Torr.

Once sufficient drying has occurred, for example to a moisture level less than 5 wt. %, alternatively less than 2 wt. %, the radiation is stopped, the pressure in the vacuum chamber is equalized with the atmosphere, and the dehydrated product is removed from the microwave-vacuum dehydrator.

According to some embodiments of the invention, the microwave-vacuum drying apparatus includes a vapour pressure booster pump. At the vacuum pressures used in the triple point drying process, for example 1 Torr to 4.5 Torr, when microwave energy is applied to a material containing frozen water, steam is generated by sublimation and the steam will be at temperatures in the range of −19.3° C. to 0° C., as tabulated in standard steam tables. It is desirable to condense most or all of this steam before the vapour reaches the vacuum pump of the microwave-vacuum dehydration apparatus because steam or water can impede the operation and damage the vacuum pump.

The condenser must be at a lower temperature than the steam to be effective;

typically the condenser temperature should be more than 10° C. lower than the steam temperature, so condensers should be at temperatures of about −30° C. to −10° C. At these pressures and temperatures, the steam will condense as ice on the condenser and must periodically be defrosted as the condenser capacity for ice is filled. If the microwave-vacuum dehydrator is a continuous throughput machine, multiple condensers will be needed, to allow for sequential defrosting and continuous drying and condensing. Defrosting of condensers requires energy input. Also, as these condensers must operate at below the freezing point, the energy consumption of the chillers that cool the condensers will also be higher than condensers that operate at temperatures above freezing.

To solve or reduce these problems, in an embodiment of the drying apparatus a vapour pressure booster pump is installed in the vacuum line downstream from the microwave-vacuum drying chamber and upstream from the condenser. Commercial booster pumps are available that can increase vapour pressure up to 10-fold; in these examples, to 1330 Pa to 6100 Pa. At those pressures, the steam temperatures will be in the range of 11.2° C. to 36° C. Steam at these pressures can be condensed to liquid water with condenser temperatures above the freezing point of water.

Since the vacuum booster provides a 10-fold pressure drop, the vacuum pump only needs to provide vacuum down to the more moderate absolute pressure range of 1330 Pa to 6100 Pa. This can be achieved with a less expensive vacuum pump, such as a liquid ring pump or a liquid ring pump with a vacuum-assist venturi system.

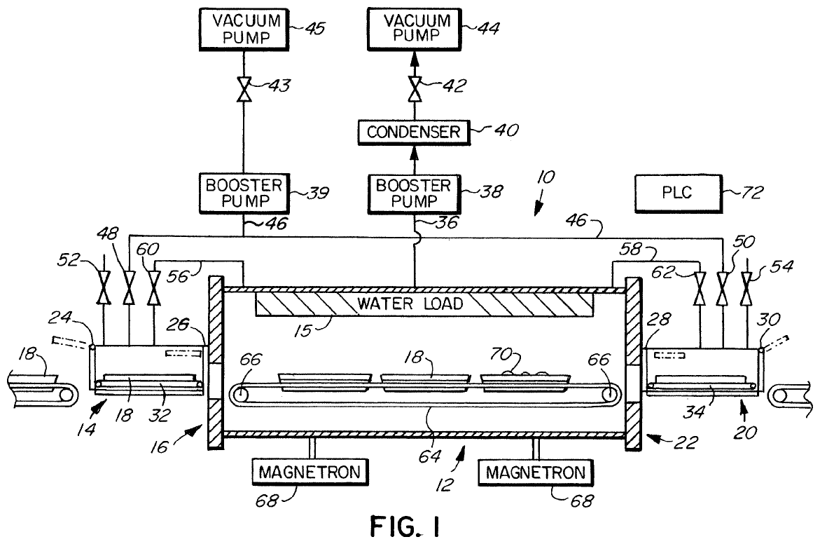

FIG. 1 schematically illustrates an embodiment of the drying apparatus incorporating a vapour pressure booster pump. The dehydrating apparatus 10 has a vacuum chamber 12 through which a tray of organic material is conveyed for dehydration. A loading module 14 is positioned at the input end 16 of the vacuum chamber for introduction of trays 18 of organic material into the vacuum chamber 12. A discharge module 20 is positioned at the output or discharge end 22 of the vacuum chamber for removal of the trays. The loading module 14 and discharge module 20 each have a pair of airlock doors, respectively 24, 26 and 28, 30 (their open position being shown by dotted lines in FIG. 1). These permit the trays to be loaded into and unloaded from the vacuum chamber, while maintaining the vacuum chamber at the reduced pressure required for the dehydration process. The loading and discharge modules 14, 20 have motor-driven conveyors 32, 34, respectively, for moving the trays.

The vacuum chamber 12 is connected via a vacuum conduit 36, a vapour pressure booster pump 38, a condenser 40 and a shut-off valve 42 to a vacuum pump 44 or the vacuum system of a plant. The loading and discharge modules 14, 20 are connected via a vacuum conduit 46, a vapour pressure booster pump 39 and shut-off valves 48, 50 and 43 to a vacuum pump 45. The loading and discharge modules are vented by discharge shut-off valves 52 and 54 respectively. A further discharge valve (not shown) is provided for venting the vacuum chamber. The loading and discharge modules 14, 20 are connected to the vacuum chamber 12 for pressure equalization by means of equalization conduits 56 and 58 and the associated shut-off valves 60 and 62, respectively.

The vacuum chamber 12 has a motor-driven conveyor 64 extending longitudinally through it and arranged to support and convey the trays 18. The conveyor runs on rollers 66 adjacent to the inlet and the outlet ends of the vacuum chamber.

Magnetrons 68 are mounted below the vacuum chamber 12 and are arranged to radiate into the vacuum chamber through appropriate waveguides and microwave-transparent windows. The magnetrons are connected to a power source (not shown) to provide the required electric power. Coolant is pumped to circulate around the magnetrons from a cooling liquid refrigeration unit. A water load 15 is provided at the upper part of the vacuum chamber 12 to absorb microwave energy and thus prevent reflection of microwaves in the vacuum chamber. The water is pumped through tubing by a water load pump (not shown).

The dehydration apparatus 10 includes a programmable logic controller (PLC) 72, programmed and connected to control the operation of the system, including the conveyor drive motors, the airlock doors, the microwave generators, the vacuum pump, the vapour pressure booster pump, the condenser, the refrigerant pump and the vacuum shut-off valves. By means of the vacuum pump, vapor pressure booster pump, condenser, refrigerant pump and vacuum shut-off valves, as well as sensors for pressure and temperature, all connected to the PLC, and the appropriate application of microwave radiation by the microwave generator, the pressure in the vacuum chamber is maintained in the range of 0.5 Torr to 4.5 Torr.

The dehydration apparatus 10 operates according to the following method. The airlock doors 26 and 30 are closed. The vacuum pumps, vapour pressure booster pumps, water load pump, conveyor drive motors and microwave generators are actuated, all under the control of the PLC 72. Pressure within the vacuum chamber is reduced to the desired pressure, i.e. in the range of 0.5 to 4.5 Torr (67-600 Pa). The organic material 70 to be dehydrated is put into a tray 18 and the tray is placed in the loading module 14. The outer airlock door 24 and shut-off valve 52 are closed and the loading module is evacuated by the vacuum pump 45 to the pressure of the vacuum chamber. The inner airlock door 26 is then opened and the tray is transported, by the conveyors 32 and 64, into the vacuum chamber 12. Once the tray is fully inside the vacuum chamber, the loading chamber 14 is prepared for receiving a second tray, by closing the inner airlock door 26 and the shut-off valves 48 and 60, opening the shut-off valve 52 to vent the loading module to atmospheric pressure, and opening the outer airlock door 24. The dehydration apparatus is thus able to process multiple trays of organic material at the same time, in a continuous process. Inside the vacuum chamber 12, the tray is moved along the conveyor 64 and the microwave generators 68 irradiate the material and dehydrate it. Vapour given off by the material is conveyed to the vapour pressure booster pump 38 where it is compressed before passing to the condenser 40 to be condensed to liquid water. The tray enters the discharge module 20, where it is conveyed toward the outer airlock door 30. The inner airlock door 28 is then closed, the shut-off valves 50, 62 are closed, the valve 54 is opened to vent the discharge module to the atmosphere, the outer airlock door 30 is opened and the tray is removed. The discharge module is prepared for the next tray to be removed from the vacuum chamber by closing the outer airlock door 30, evacuating the discharge module by means of vacuum pump 45 to the reduced pressure of the vacuum chamber, and opening the inner airlock door 28. Following either loading or discharge of a tray from the loading module or discharge module, the vacuum pump 45 draws gases from the loading or discharge module, through the vacuum conduit 46, without disturbing the vacuum in the vacuum chamber 12.

There are several advantages of employing the vapour pressure booster system. Multiple condensers are not required because defrosting is not required. Liquid condensate may be discharged from the condensers periodically through a condensate release valve (a type of an air lock). Energy consumption of condensation is less with the higher temperature condensers. Energy consumption of defrosting condensers is avoided. A lower cost vacuum pump can be used; energy consumption of this vacuum pump will also be less at the higher absolute pressure.

### EXAMPLES

Experiments were done to determine the difference between conventional microwave-vacuum drying at high vacuum, and triple point drying. It was found that triple point drying results in faster drying, reduced energy consumption and reduced final product temperature.

Example 1—Yogurt 500 gram samples of yogurt were dried using a microwave-vacuum dehydrator at high vacuum (100 mTorr) and in accordance with the invention (3550 mTorr). In both cases, the apparatus was a quantaREV dehydrator manufactured by EnWave Corporation. The operating conditions and results are shown in the following table.

| | | | | Final | Final product |
|---|---|---|---|---|---|
| Sample | Pressure | Dehydration | Energy | Moisture | temperature |
| No. | (mTorr) | time (hours) | (kwh) | (wt. %) | (° C.) |
| 1. | 100 | 6 | 14 | 2% | 26 |
| 2. | 3550 | 2 | 6.8 | 1.9% | 25.8 |

Example 2—Pharmaceutical Placebo 500 g samples of a pharmaceutical placebo comprising 4% whey protein isolate, 5% sucrose and 95.17 mM NaCl were subjected to microwave vacuum drying in a quantaREV dehydrator. One sample was dried at a pressure of 100 mTorr and a second sample at 750 mTorr.

| | | | | Final | Final Product |
|---|---|---|---|---|---|
| Sample | Pressure | Dehydration | Energy | Moisture | Temperature |
| No. | (mTorr) | time (hours) | (kwh) | (wt. %) | (° C.) |
| 1. | 100 | 8 | 28.7 | 3% | 45 |
| 2. | 750 | 7 | 9.7 | 3% | 29 |

Control of the final product temperature is crucial in the drying of most bioactive formulations. Here, lower product temperature was achieved using triple point drying due to the lower power employed, as compared to the low pressure example.

Example 3—Anthocyanin Extract 250 g samples of anthocyanin extract were dried at a pressure of 100 mTorr and at a pressure of 550 mTorr, respectively. The operating conditions and results are shown in the following table.

| | | | | Final | Final Product |
|---|---|---|---|---|---|
| Sample | Pressure | Dehydration | Energy | Moisture | Temperature |
| No. | (mTorr) | time (hours) | (kwh) | (wt. %) | (° C.) |
| 1. | 100 | 9.5 | 8.2 | 3.4% | 38 |
| 2. | 550 | 4.5 | 3.7 | 3.1% | 32 |

Example 4—Banana 400 g samples of banana were dried at a pressure of 100 mTorr and at a pressure of 2200 mTorr, respectively. The operating conditions and results are shown in the following table.

| | | | | Final | Final Product |
|---|---|---|---|---|---|
| Sample | Pressure | Dehydration | Energy | Moisture | Temperature |
| No. | (mTorr) | time (hours) | (kwh) | (wt. %) | (° C.) |
| 1. | 100 | 8.5 | 7.5 | 3.5 | 37 |
| 2. | 2200 | 2.5 | 3.5 | 3.0 | 38 |

The method of the invention is useful in preventing or reducing enzymatic reactions in food products. Water activity and temperature are known to be key factors in the development of enzymatic and non-enzymatic reactions in foods. They become more important when time is a factor in these reactions. In triple point drying, water activity and temperature are controlled at the beginning of the process while most of the frozen water is bound. In the second step of drying the residue of moisture could be removed rapidly through the created porous structure, by rapid increment of the microwave power. Therefore, these samples could be dried in a low water activity and temperature over a short period.

Banana and some other tropical fruits exhibit an extensive browning reaction during drying. In prior art microwave-vacuum drying processes for dehydration of fruits, a preliminary air-drying step is required, causing enzymatic browning, which is conventionally minimized by the addition of ascorbic acid or sulfur dioxide. need to be added to minimize enzymatic browning of the fruits. The use of sulfur dioxide in foods has been questioned from a health perspective. Triple point drying is an effective method for reducing both enzymatic and non-enzymatic reactions by controlling unbounded water, which is needed for the browning reactions, as well as by reducing the time required for drying. The water activity (Aw) of the triple point dried fruits is low enough (Aw<0.2) to be color stable during long-lasting storage.

Example 5—Avocado 400 g samples of avocado were dried at a pressure of 100 mTorr and at a pressure of 2500 mTorr, respectively. The operating conditions and results are shown in the following table.

| | | | | Final | Final Product |
|---|---|---|---|---|---|
| Sample | Pressure | Dehydration | Energy | Moisture | Temperature |
| No. | (mTorr) | time (hours) | (kwh) | (wt. %) | (° C.) |
| 1. | 100 | 8 | 8.6 | 3.5 | 36 |
| 2. | 2500 | 2.5 | 2.9 | 3.0 | 38 |

Dehydration has always been one the best technologies to preserve most fruits; however, fruits like avocado need more consideration due to variety of enzymatic and oxidative reactions occurring in the fruit during dehydration. In triple point drying, the water is frozen during most of drying time and oxidation is controlled by virtue of the low pressure (2.5 Torr) and the speed of the drying process (2.5 hours). Color can be used as an index to denote transformations occurring in natural fresh fruits or during the drying process. The color of the triple point dried avocado was natural and green with no sign of browning reaction.

Example 6—Color differences between air drying, freeze drying and triple point drying.

Color difference (LE) is the difference or distance between two colors. It is a metric of interest in food science (see Peter. S. Murano (2003), “Sensory evaluation and food product development,” Understanding food science and technology (425). Belmont, Calif.: Thomson Wadsworth). The following tables shows the ΔΕ color difference, and drying time of bananas and avocadoes dried by conventional air drying, conventional freeze drying, and triple point drying according to the invention, compared to the fresh fruits. The ΔΕ of triple point dried fruit is smaller than that of air dried or freeze dried fruit, indicating that the colour of triple point dried fruit is closer to that of the fresh fruit.

Delta E

| | Air | Freeze | Triple point |
|---|---|---|---|
| | dried | dried | dried |
| Avacado | 29.3 | 4.6 | 3.9 |
| Banana | 21.2 | 19.7 | 16.2 |

Drying time (h)

| | Air | Freeze | Triple point |
|---|---|---|---|
| | dried | dried | dried |
| Avacado | 16 | 72 | 2.5 |
| Banana | 14 | 72 | 2.5 |

As will be apparent to those skilled in the art in the light of the foregoing disclosure, many alterations and modifications are possible in the practice of this invention without departing from the scope thereof. The scope of the invention is to be construed in accordance with the following claims.

What is claimed is:

1. A method of drying an organic material, comprising:
(a) introducing the organic material into a microwave-vacuum dehydrator;
(b) exposing the organic material to microwave radiation in the dehydrator to dry the organic material by sublimation;
(c) maintaining pressure in the dehydrator in the range of 0.5 Torr to 4.5 Torr (67 to 600 Pa) during step (b); and
(d) removing the dried organic material from the dehydrator.

2. A method according to claim 1, wherein the pressure is in the range of 0.55 to 3.4 Torr (73 to 453 Pa) during step (b).

3. A method according to claim 1, further comprising the step of freezing the organic material prior to introducing it into the microwave-vacuum dehydrator.

4. A method according to claim 1 further comprising the steps of compressing water vapour generated by said drying and thereby raising its temperature, and condensing the compressed water vapour.

5. A method according to claim 1, wherein the organic material is dried to a moisture content less than 5 wt. %.

6. (canceled)

7. A method according to claim 1, wherein the organic material comprises one of a fruit, a vegetable, a fruit juice, a vegetable juice, a pre-cooked grain, a hydrocolloid, a vegetable gum, a bacterial culture, a vaccine, an enzyme, a protein isolate, an amino acid, an injectable drug, a pharmaceutical drug, a natural medicinal compound, an antibiotic, an antibody, meat, fish, seafood, milk, cheese, whey protein isolate, yogurt, a fruit extract, a vegetable extract and a meat extract.

8. A method according to claim 7, wherein the organic material is one of fresh and frozen.

9. A method according to claim 7, wherein the organic material is encapsulated in a hydrocolloid.

10-11. (canceled)

12. A method according to claim 1, further comprising the step of flowing water through tubing in the dehydrator to absorb microwave energy.

13. A method of drying an organic material comprising:
(a) exposing the organic material to microwave radiation in a vacuum chamber;
(b) maintaining conditions in the vacuum chamber below the triple point of water, with a pressure in the vacuum chamber in the range of 0.5 Torr to 4.5 Torr (67 to 600 Pa), during step (a); and
(c) removing the dried organic material from the vacuum chamber.

14. A method according to claim 13, wherein said drying is by sublimation.

15. A method according to claim 13, wherein the pressure is in the range of 0.55 to 3.4 Torr (73 to 453 Pa) during step (a).

16. A method according to claim 13, further comprising the step of freezing the organic material prior to introducing it into the vacuum chamber.

17. A method according to claim 13, further comprising the steps of compressing water vapour generated by said drying and thereby raising its temperature, and condensing the compressed water vapour.

18. A method according to claim 13, wherein the organic material is dried to a moisture content less than 5 wt. %.

19. (canceled)

20. A method according to claim 13, wherein the organic material comprises one of a fruit, a vegetable, a fruit juice, a vegetable juice, a pre-cooked grain, a hydrocolloid, a vegetable gum, a bacterial culture, a vaccine, an enzyme, a protein isolate, an amino acid, an injectable drug, a pharmaceutical drug, a natural medicinal compound, an antibiotic, an antibody, meat, fish, seafood, milk, cheese, whey protein isolate, yogurt, a fruit extract, a vegetable extract and a meat extract.

21. (canceled)

22. A dried organic material made by the method of claim 1.

23. An apparatus for dehydrating organic matter, comprising:
(a) a vacuum chamber;
(b) a magnetron arranged to radiate microwaves into the vacuum chamber;
(c) a vacuum source for reducing pressure inside the vacuum chamber; and
(d) means for maintaining the pressure inside the vacuum chamber in the range of 0.5 Torr to 4.5 Torr (67 to 600 Pa).

24. An apparatus according to claim 23, further comprising:
(e) a vapour pressure booster pump arranged downstream of the vacuum chamber for compressing water vapour produced in the vacuum chamber; and
(f) a condenser arranged downstream of the vapour pressure booster pump for condensing the compressed water vapour.

25-27. (canceled)

28. An apparatus according to claim 23, wherein the means for maintaining the pressure in the vacuum chamber comprises a programmable logic controller.

29-34. (canceled)
